(19) United States
(12) Patent Application Publication
(10) Pub. No.: US 2011/0185976 A1
(43) Pub. Date: Aug. 4, 2011

(54) CAT LITTER SYSTEM

(76) Inventor: Michael J. Egy, Terre Haute, IN (US)

(21) Appl. No.: 13/014,400

(22) Filed: Jan. 26, 2011

Related U.S. Application Data
(60) Provisional application No. 61/299,382, filed on Jan. 29, 2010.

(51) Int. Cl. A01K 29/00

(52) U.S. Cl. 119/162; 119/161

(57) ABSTRACT

Aspects of the present disclosure provide a cat litter system which preferably holds cat litter for use by a cat, and thereafter facilitates disposal of the material. In certain embodiments, the system can be arranged on a toilet and left in place for use by the cat when needed, or alternately, the system can be placed elsewhere before and during use by the cat, and can then be placed over a toilet seat or other receptacle for the disposal step. Certain embodiments preferably provide a base with a substantially flat upper surface with an open central area filled with a cup arrangement. Cat litter material is preferably placed in the cup arrangement for use. Once the cat has used the cat litter material, the system preferably allows the cup arrangement to be opened, allowing the used litter material to fall through into a disposal receptacle, for example a toilet bowl.

This application claims the benefit of U.S. Provisional Patent Application No. 61/299,382, filed Jan. 29, 2010, which is hereby incorporated by reference in its entirety.

### FIELD OF THE INVENTION

Aspects of the present application deal with a portable cat litter box and disposal system, preferably usable with a toilet.

### BACKGROUND OF THE DISCLOSURE

House cats are often trained to use a litter box in which the cat deposits waste materials into cat litter. After such use, the caretaker typically disposes of the cat litter and waste and thereafter refreshes the litter box with new cat litter material. Aspects of the present disclosure facilitate disposal of used cat litter material, allowing the litter box to be refreshed.

### SUMMARY OF THE INVENTION

Aspects of the present disclosure provide a cat litter system which preferably holds cat litter for use by a cat, and thereafter facilitates disposal of the material. In certain embodiments, the system can be arranged on a toilet and left in place for use by the cat when needed, or alternately, the system can be placed elsewhere before and during use by the cat, and can then be placed over a toilet seat or other receptacle for the disposal step. Certain embodiments preferably provide a base with a substantially flat upper surface with an open central area filled with a cup arrangement. Cat litter material is preferably placed in the cup arrangement for use. Once the cat has used the cat litter material, the system preferably allows the cup arrangement to be opened, allowing the used litter material to fall through into a disposal receptacle, for example a toilet bowl.

Certain embodiments of the present disclosure provide a cat litter system having a base configured to be supported on a support rim. The support rim defines a dump area into which cat litter can be dumped. The base has an upper surface and defines an opening extending through the upper surface and the base wherein the opening is arranged over the dump area. The cat litter system further comprises a cup arrangement situated in the opening and rotatably mounted to the base. The cup arrangement is configured to hold cat litter in a closed position. The cup arrangement is rotatably operable to an open position to dump the cat litter into the dump area.

Additional embodiments of the present disclosure provide a cat litter system which contains a base configured to be supported on a support rim. The cat litter system further comprises a cup arrangement extending over the support surface and downward into the opening and mounted to the base. The cup arrangement is configured to hold cat litter in a closed position, and the cup arrangement is rotatably operable to an open position to dump the cat litter into the dump area. The cup arrangement includes at least two cup portions which cooperate in the closed position to substantially fill the cross-sectional area of the opening.

Additional embodiments and aspects of the disclosure will become apparent from the description, claims and drawings herein.

### BRIEF DESCRIPTION OF THE DRAWINGS

FIG. 1 is a perspective view of a cat litter system according to a preferred embodiment illustrated in place on a toilet.

FIG. 2 is a perspective view of the cat litter system embodiment of FIG. 1 in a closed position.

FIG. 3 is a front perspective view of the embodiment of FIG. 2 in a partially opened position.

FIG. 4 is a perspective view of the embodiment of FIG. 2 in an open position.

FIGS. 5-8 are lower perspective, plan and side views of the embodiment of FIG. 2.

FIGS. 9-12 are perspective, plan and side views of the base portion of the embodiment of FIG. 2.

FIGS. 13-16 are perspective, plan and side views of the wing portions of the embodiment of FIG. 2.

### DESCRIPTION OF ILLUSTRATED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

Aspects of the present disclosure provide a cat litter system which preferably holds cat litter for use by a cat, and thereafter facilitates disposal of the material. In certain embodiments, the system can be arranged on a support rim, such as a toilet and left in place for use by the cat when needed, or alternately, the system can be placed elsewhere before and during use by the cat, and can then be placed over a toilet seat or other receptacle for the disposal step. Certain embodiments preferably provide a base with a substantially flat upper surface with an open area in the middle filled with a cup arrangement having one or more cup portions. Cat litter material is preferably placed in the cup arrangement for use by a cat. The upper surface of the system can be smooth to assist in cleaning and hygiene, or alternately may have some texture to provide traction for a cat getting onto or off the system. Once the cat has used the cat litter material, the system preferably allows the cup arrangement to be opened, allowing the used litter material to fall through into a dump area, for example a disposal receptacle or a toilet bowl.

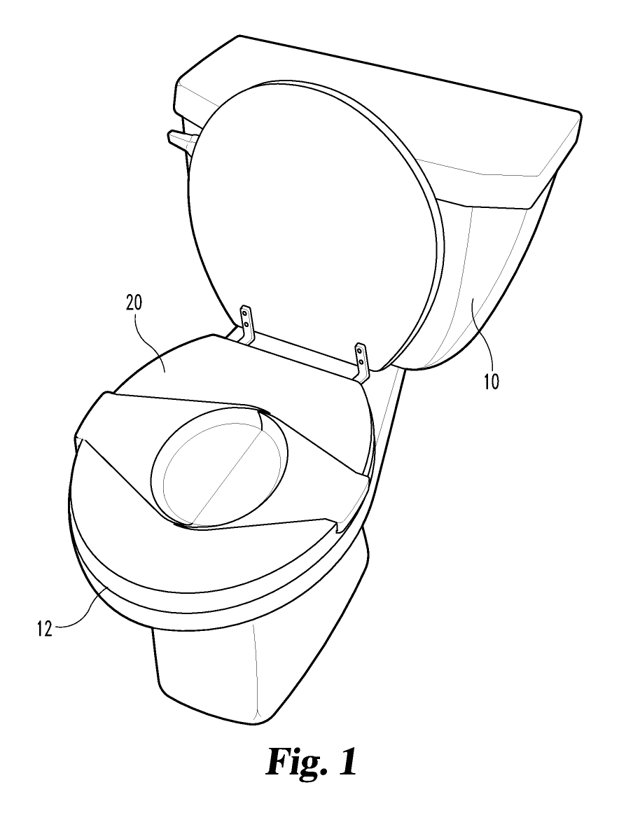

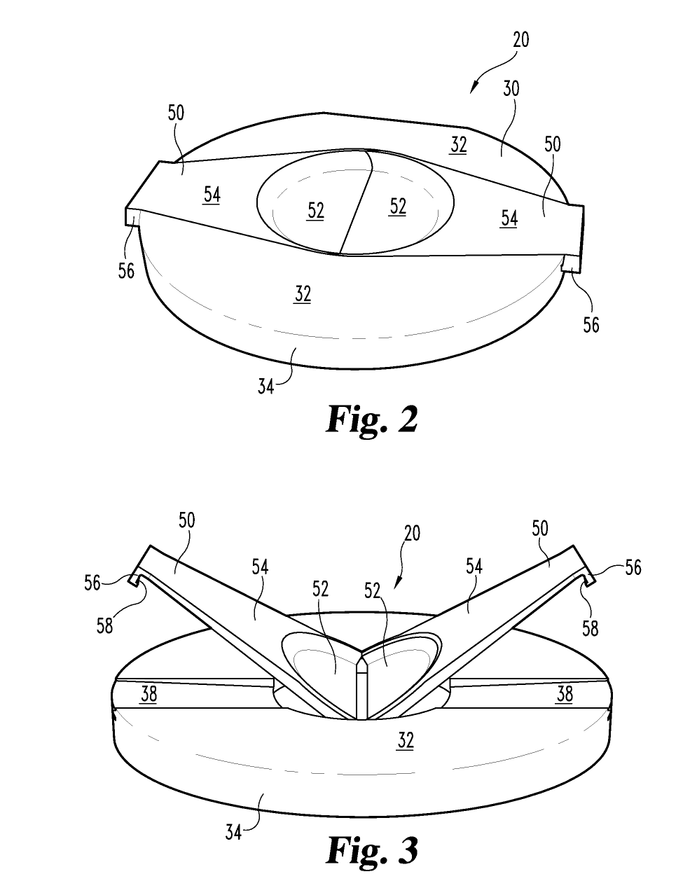

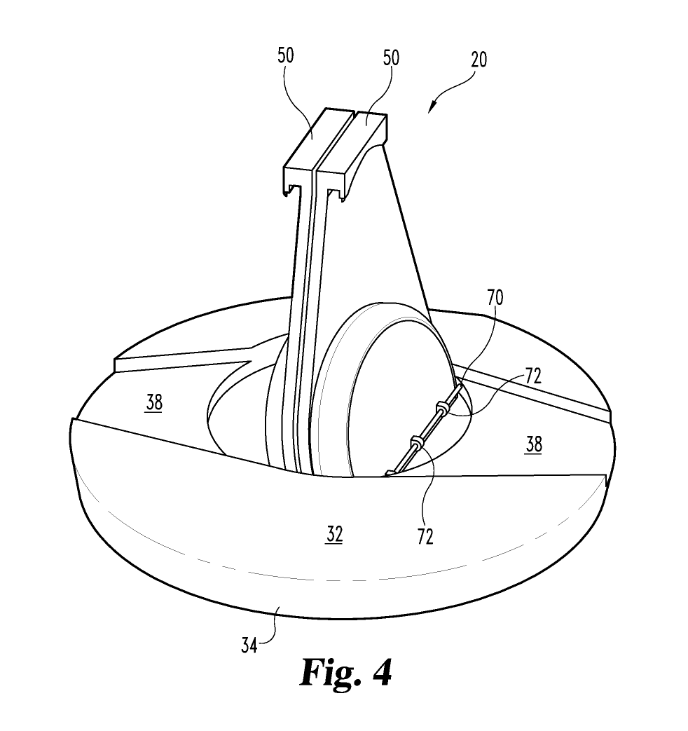

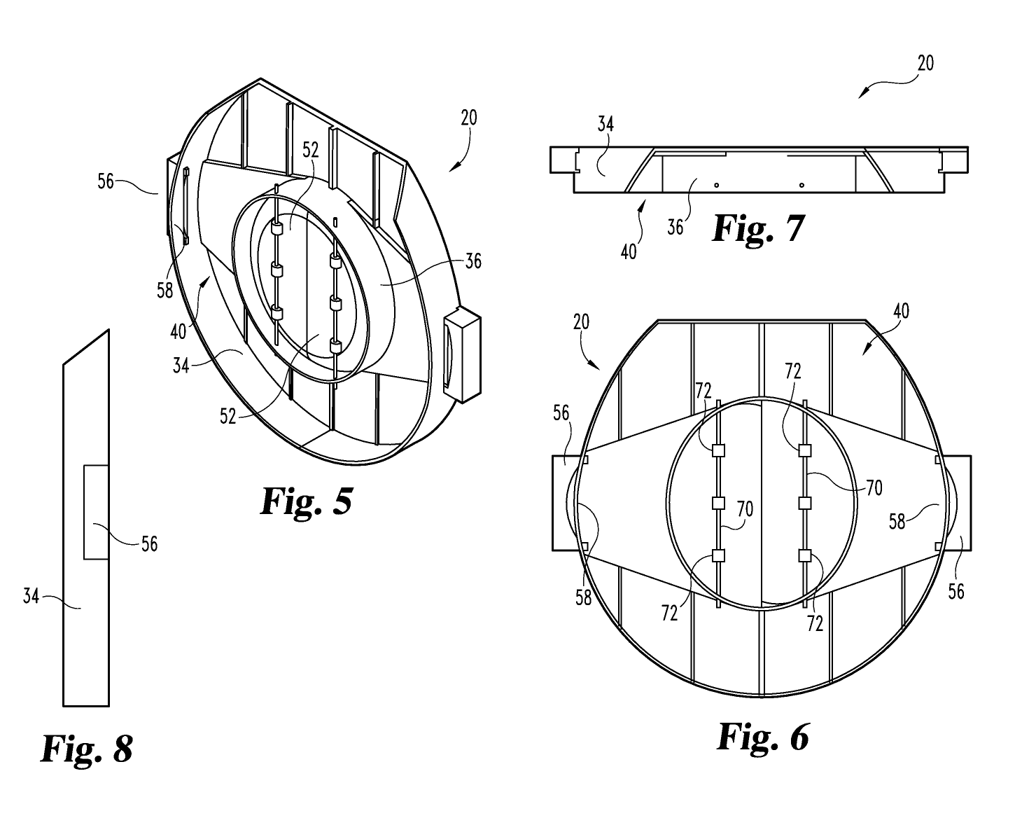

The embodiment of FIGS. 1-8 illustrates a cat litter system 20 arranged on a support such as a toilet 10 typically having a seat 12. The lower side of system 20 preferably receives and is supported by a rim of the support such as seat 12. The system 20 generally includes a base 30 and two wing pieces 50.

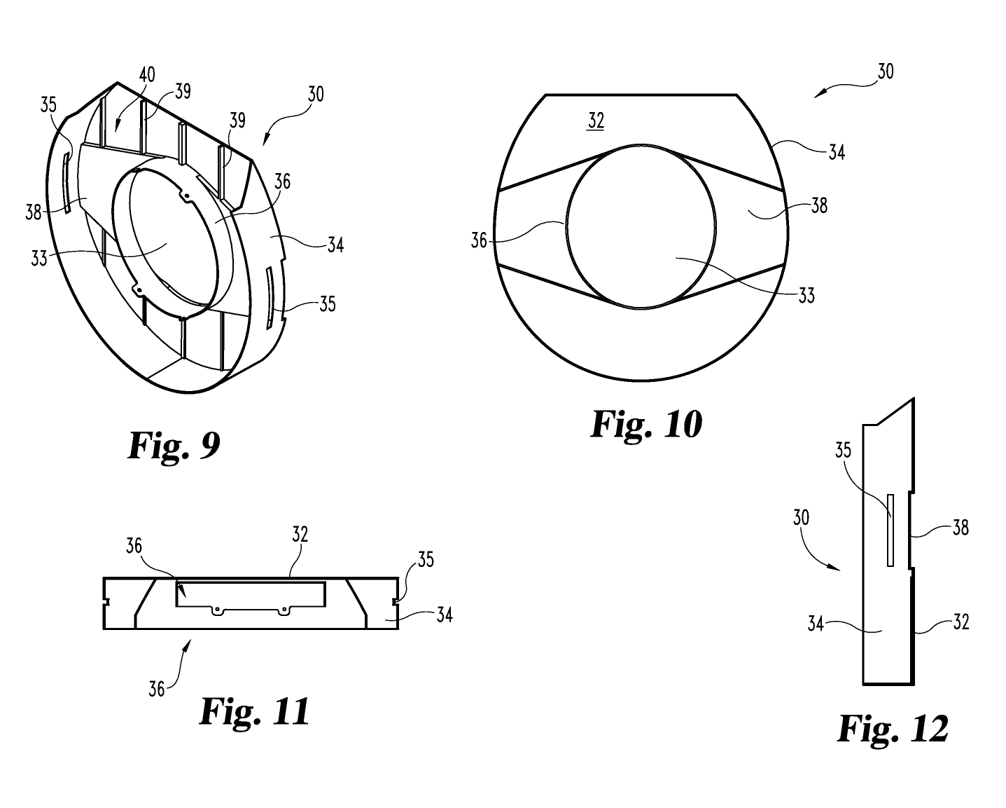

Base 30, shown in detail in FIGS. 9-12, forms a substantially flat upper surface 32 generally across its length and width. At the outer periphery of upper surface 32, outer ring wall 34 extends downward. Outer ring wall 34 preferably has a rearward facing gap to accommodate the portion of the toilet and hinges at the rearward portion of the seat. The ring wall can be continuous or can be a series of wall portions at selected points.

An opening 33 is defined through base 30 in the central area of upper surface 32, for example a circle, which is arranged to receive a cup arrangement, namely cup portions 52 of the wings 50. The diameter of the central opening 33 optionally defines a downward extending inner ring wall 36. The lower side of base 30 in combination with outer ring wall 34 and inner ring wall 36 preferably define a seat receiving area 40 sized and shaped to receive seat 12 to support the system 20 and to hold it from movement. The lower side of base 30 may include reinforcing ribs 39. System 20 is illustrated with substantially circular ring walls, although alternate geometries can be used as desired to match the desired contours and shape of the toilet seat. For example, one version may fit a standard shaped toilet seat while an alternate version may be more oval shaped to accommodate an elongated seat. In alternate options, only one of an inner or outer ring wall may be used or only alignment tabs instead of wall portions are used.

In some embodiments, the base may be sized and configured to fit the rim of a toilet bowl when the seat is raised. In still further embodiments, the base may be sized and shaped to fit the rim or periphery of other supports with dump areas into which litter in the cup portions can be dumped. A dump area is typically a central area with a height lower than the height of the support rim. Examples of such supports may include trash cans, trays or buckets with curved or polygonal peripheries. The walls of the system base may be sized to surround or fit within or around such peripheries, with the base having a shelf portion or portions supported on the top or rim of the support. Alternately, the base may have a wall with a height which supports the upper surface at a desired height over a support surface.

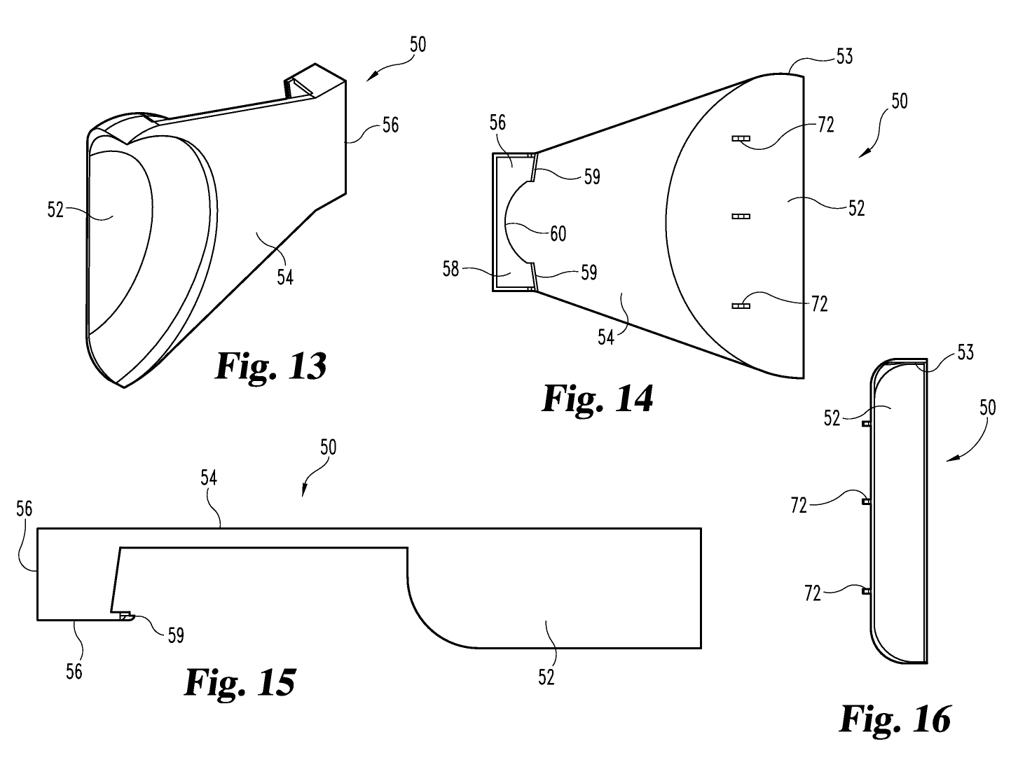

System 20 further includes a pair of wings 50, shown in detail in FIGS. 13-16, and illustrated in FIGS. 1-2 extending from opposing peripheral edges of over base 30 and extending into the central opening 33. Each wing includes a cup portion 52 having a size and shape configured to fill substantially half of the cross-section of the central opening and cooperating to form a cup arrangement to fill the entire cross-section of the opening. The cup portion 52 extends slightly downward into the central opening so that the wings form a cup to receive and support the cat litter material at a height equal to or below upper surface 32. In alternate embodiments, one wing is used with a cup filling the central opening or a plurality of wings and cup portions may cooperate to fill the central opening.

In the illustrated embodiment, at least one of the side wall edges of each cup piece is formed with a taper or radius to allow the sidewall portions to be closely adjacent in the closed position yet to allow clearance of movement without binding when the wings are rotated to open the cup arrangement. In some embodiments, the outer edge of one side wall of the cup is curved horizontally slightly radially inward 53 and forms a slight side-by-side passing arrangement with a non-curved side wall edge of an opposing cup portion. In an alternate embodiment, the opposing side wall edges are curved slightly toward the handle along their vertical height so that opposing side wall edges will not touch or will roll against each other as the cup portions are rotated. These arrangements preferably allow clearance for the cup portions to be opened yet substantially prevents gaps where cat litter could escape when closed.

Each cup portion 52 forms one end of a tapered arm portion 54 which extends outward to the peripheral edge of system 20. An outer end of each arm portion 54 forms a handle 56 which can be grasped and operated by a user to operate the system.

In certain embodiments, the lower portion 50 of each handle 56 includes a retaining lip or tab 59 on an inner edge which extends inward slightly under outer ring wall 34 or into a slot 35 in the side wall when wing 50 is in a lowered position. The retaining lip 59 preferably selectively locks the wing arm portion in place to prevent unintentional upward movement and dumping of the litter. Lip 58 is disengaged using a slight outward bending motion on the handle when movement of the wing is desired. In some embodiments, lower handle portion 58 includes an arcuate portion 60 forming a gap between handle 56 and wall 34 to assist a user to grasp and pull outward on the handle.

In the illustrated embodiment, each wing 50 is rotatably mounted to base 30 using a hinge rod 70 which extends through hinge mounts 72 extending from the lower side of cup portion 52. The hinge rod 70 extends to aligned openings in inner ring wall 36, and allows the wings 50 to be mounted to base 30 in a rotating relationship. The ends of each hinge rod may be secured from sliding with fasteners such as clips, caps or nuts or may be frictionally held in place. In the illustrated embodiment, the hinge rods 70 extend across parallel offset chords of the central opening.

In certain preferred embodiments, base 30 defines inset areas or stepped down portions 38 configured to accommodate the length and thickness of wing arm portions 54. The stepped down portions 38 preferably allow the arm portions to fit or nest into a recessed arrangement in the downward position, allowing the upper surface of each arm portion 54 to be substantially flush and level with upper surface 32 of base 30. In alternate embodiments, a wing piece can extend across the top of a base portion with the top surface being slightly above or below the top surface of the base.

In use, disposable cat litter, for example flushable litter, is arranged in the cup arrangement in the closed position to allow use by a cat. When it is time to dispose of the litter, the outer handles 56 of the wing portions 50 are pulled slightly outward to disengage retaining lips 59 from outer ring wall 34, and the handles are each rotated upward to rotate the wings around hinge rods 70. The handles are pushed together, separating the cup portions to form an opening, allowing the litter to fall or be dumped downward into the bowl of the toilet or an other receptacle. After the litter is disposed of, the wings are rotated downward and the cup portions are returned to a closed position. The handles are preferably pressed downward a sufficient distance to allow retaining lips 58 to engage outer ring wall 34 or slots 35.

In certain embodiments, system 20 preferably can be arranged on toilet 10 in an arrangement for daily use and the cat is trained to use system 20 in place on a toilet. Alternately, the assembly can be mounted on a support or used as a stand alone system separate from a toilet, and then placed over the bowl of a toilet or another receptacle for the disposal step. After disposal of used cat litter, the system can be filled with fresh cat litter and left in place or returned to a separate location.

Various materials may be used to make system 20 as would be understood by those with skill in the art. Preferably, materials are selected to facilitate ease of use by the cat as well as ease of use in disposing of litter material and general cleaning. Examples of suitable materials include plastic, rubber, metal or wood. Preferably the material used is sealed and/or nonporous to assist in cleaning and hygiene.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A cat litter system, comprising:
a. a base configured to be supported on a support rim, the support rim defining a dump area into which cat litter can be dumped, said base having an upper surface and defining an opening extending through said upper surface and said base wherein said opening is arranged over the dump area;
b. a cup arrangement situated in said opening and rotatably mounted to said base, wherein said cup arrangement is configured to hold cat litter in a closed position, and wherein said cup arrangement is rotatably operable to an open position to dump the cat litter into the dump area.

2. The system of claim 1, wherein said cup arrangement includes at least two cup portions which cooperate in the closed position to substantially fill the cross-sectional area of said opening.

3. The system of claim 2, wherein said cup portions extend to handle portions which can be grasped by a user to rotate the cup portions between an open position and a closed position.

4. The system of claim 3, wherein cup portions include wing arm portions extending between said cup portions and said handle portions, wherein said wing arm portions are received in nest areas defined in said base upper surface such that the upper surface of said wing arm portions is level with the base upper surface when said cup arrangement is in the closed position.

5. The system of claim 3, wherein said cup arrangement is selectively retainable in the closed position to prevent unintended dumping of the cat litter.

6. The system of claim 5, wherein said handle portions include retaining tabs which engage said base in the closed position.

7. The system of claim 6, wherein said retaining tabs engage corresponding slots defined in said base.

8. The system of claim 1, wherein said base includes a vertical ring wall which engages the support rim to prevent unintended movement of the base relative to the support.

9. The system of claim 8, wherein the support is a toilet with a seat as a support rim and wherein said base defines a seat receiving area matching the profile of the seat to support the system on the toilet seat.

10. The system of claim 1, wherein said base includes an outer peripheral wall and an inner peripheral wall which receive the support rim therebetween to prevent unintended movement of the base relative to the support.

11. A cat litter system, comprising:
a. a base configured to be supported on a support rim, the support rim defining a dump area into which cat litter can be dumped, said base having an upper surface and defining an opening extending through said upper surface and said base wherein said opening is arranged over the dump area;
b. a cup arrangement extending over said support surface and downward into said opening and mounted to said base, wherein said cup arrangement is configured to hold cat litter in a closed position, and wherein said cup arrangement is rotatably operable to an open position to dump the cat litter into the dump area, said cup arrangement including at least two cup portions which cooperate in the closed position to substantially fill the cross-sectional area of said opening.

12. The system of claim 11, wherein said cup portions extend to handle portions which can be grasped by a user to rotate the cup portions between an open position and a closed position, said cup portions and handle portions defining wing arm portions therebetween, wherein said wing arm portions extend from said opening over said base and to the perimeter of said upper surface in the closed position.

13. The system of claim 13, wherein said wing arm portions are received in nest areas defined in said base upper surface such that the upper surfaces of said wing arm portions are level with the base upper surface when said cup arrangement is in the closed position.

14. The system of claim 13, wherein said handle portions include retaining tabs which engage slots defined in said base in the closed position.

15. The system of claim 12, wherein the support is a toilet with a seat and wherein said base defines a seat receiving area matching the profile of the seat to support the base on the toilet seat.

16. The system of claim 12, wherein said cup portions include tapered sidewall edges to allow the sidewalls of said cup portions to be closely adjacent in the closed position yet to allow clearance for the sidewall edges to open without binding when the cup arrangement is moved to the open position.

17. The system of claim 16, wherein said cup portions are rotatably engaged to said base.

18. The system of claim 12, wherein said opening is circular.

19. A cat litter system, comprising:
a. a base configured to be supported on a support rim, the support rim defining a dump area into which cat litter can be dumped, said base having an upper surface and defining an opening extending through said upper surface and said base wherein said opening is arranged over the dump area;
b. a cup arrangement extending from said support surface downward into said opening and mounted to said base, wherein said cup arrangement is configured to hold cat litter in a closed position, and wherein said cup arrangement is rotatably operable to an open position to dump the cat litter into the dump area, said cup arrangement substantially filling the cross-sectional area of said opening in said closed position, wherein said cup arrangement has at least one handle portion arranged adjacent an outer edge of said base, and wherein said handle portion can be grasped by a user to rotate the cup arrangement between the open position and the closed position.

20. The system of claim 19, wherein the support is a toilet with a seat and wherein said base defines a seat receiving area matching the profile of the seat to support the base on the toilet seat.
